(19) United States
(12) Patent Application Publication
(10) Pub. No.: US 2007/0030672 A1
(43) Pub. Date: Feb. 8, 2007

(54) Led light

(76) Inventors: Stephen B. Offiler, Sterling, CT (US); David Gendreau, Cranston, RI (US); Marcus Poisson, Pawtucket, RI (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/197,277

(22) Filed: Aug. 4, 2005

(51) Int. Cl. F21L 4/04

(52) U.S. Cl. 362/198; 362/199; 362/396

(57) ABSTRACT

The lamp head of an LED utility light provides LED elements, a housing, a power source, and optical means produces from the LED element output a substantially clean and uniform light beam over at least 24-32 inches from the lamp head. In another embodiment, a flexible stalk is connected at one end to the housing and at the other to the lamp head. Yet another embodiment shows a LED module, secondary optics and a heat sink; a renewable power source, a flexible neck linked at one end to the housing and at the other supporting a lamp head housing an LED elements array. Optical means produces a substantially uniform light beam from the LED element to a distance of at least 5 feet from the lamp head, the flexible neck having quick-release capacity to allow alternation between white LED die and blue ultraviolet LED die.

### BACKGROUND OF THE INVENTION

1. Field of the Invention

The present invention relates to a light-emitting diode (LED) light assembly. More particularly, the present invention relates to a readily positionable LED light assembly that is adapted to provide a substantially clean and uniform beam of light.

2. Description of the Prior Art

Portable lighting devices of the type frequently known as shop, work, utility or task lights, and other portable lighting devices have limitations in that they often fail to provide a clean light beam. Often, the emitted light has bright or shady spots. These obstructions to the light beam may be caused by the interference of a filament with the emitted light beam. A clean and uniform beam of light is necessary to provide a bright beam over a distance.

Work lights also require a clean and bright beam of light. One of the essential requirements for work in a close or confined work space is adequate lighting. Non-limiting examples of a confined work space include the engine compartment, the space below the dashboard, or the chassis of an automobile.

General lighting such as fluorescent overhead lighting typically available in a workspace, such as in a garage, is insufficient for close work. The shadows cast by the many components of an object of work make working without directed illumination nearly impossible.

A typical lighting solution has been the conventional shop light which includes an incandescent or fluorescent light bulb surrounded on one side by a protective cage and on the other side by a reflective plate. A hook is usually provided for hanging the light from an overhead support. The hook is either a fixed device or a swivel device attached to the reflective plate or the protective cage. The shop light hangs by the hook and is oriented by a worker to direct the light as needed. One limitation of the shop light is finding a suitable location for hanging. Also, when suspended by a swivel hook, the light frequently rotates or moves. The light output direction shifts, thereby reducing its usefulness.

Shop lights are adequate for general work, but do not provide adequate light for working in close or confined work areas. Moreover, these types of lights are usually too large and cumbersome to fit into constricted workspaces. As a result, light cannot be directed into the desired locations due either to obstructions or the physical size of the components. Also, many of the existing work or utility lights reach uncomfortably high temperatures over an extended use period and these can become hazardous to the user when used in a close work space.

Additionally, shop lights emit diluted or less intense light in a broad area, rather than concentrating light on a particular desired location. The further a light is positioned away from the work space, the more diluted the light intensity. Thus, shop lights often emit an “overspray” of light. This “overspray” is very distracting and can cause eye irritation. The eye irritation can also lead to time consuming and dangerous working conditions.

Light-emitting diodes (LEDs) are a commonly used light source in applications including lighting, signaling, signage, and displays. LEDs have several advantages over incandescent and fluorescent lamps, including high reliability, long lifetime, and high efficiency.

U.S. Pat. No. 6,231,207 to Kennedy et al. discloses a light emitting diode flashlight lamp. This reference discloses the use of an LED as a direct source of light for a flashlight assembly. As shown, the LED is contained in an end cap housing that is threaded onto an end of a translucent cylinder. In this manner, the end cap, and corresponding LED can be positioned to shine light away from the cylindrical tube (i.e., in flashlight mode) or can be positioned to shine light into the cylindrical tube (i.e., in lamp mode). Even with the bright white light LEDs currently available, the LED light source fails to provide a light source having optic tolerances that provide a sufficiently clean, broad and intense light.

A need therefore exists for a readily positionable compact LED light assembly that is adapted to provide a clean, broad and uniform light whether over a distance or in a confined workplace.

### SUMMARY OF THE INVENTION

It an object of the present invention to provide a portable light that is free of filament shading or bright spots.

It is another object of the present invention to provide a light that utilizes one or more LEDs as the light source.

It is also an object of the present invention to provide a light having LED optics spatially arranged such that the light tolerances provide a clean and bright light.

It is another object of the present invention to provide an LED work or utility light that provides a substantially uniform and bright light over distances encountered by workers, such as automobile mechanics, under typical working conditions.

It is a further object of the present invention to provide an LED utility or work light that provides a substantially clean, uniform and bright light in a confined workspace.

It is yet another object of the present invention to provide an LED utility light having an optical means that is positioned on a flexible neck.

It is still another object of the present invention to provide an LED utility light that provides a lighted area approximately twenty inches in diameter at a distance of approximately 24 to 32 inches.

It is still a further object of the present invention to provide an LED utility light wherein the angle of dispersion of the LED light beam is approximately between 35 degrees and 45 degrees.

It is a yet further object of the present invention to provide an LED utility light having means for securing the utility light housing to a surface within a work space.

These and other objects and advantages of the present invention are achieved by an LED work or utility light comprising a lamp head, which houses an array of LED elements, and an optical means, as well as a housing and a power source, that generates the output of the LED elements and produces a substantially clean and uniform beam of light over a range extended from the lamp head to a distance of at least 24 to 32 inches.

The objects and advantages of the present invention are also achieved by an LED utility light comprising a lamp head, which houses an array of LED elements, a housing, a power source, a flexible neck that is connected at a first end to said housing and at a second end to said lamp head, and an optical means that takes the output of the LED elements and produces a substantially clean and uniform beam of light over a range extended from said lamp head to a distance of at least five feet.

### BRIEF DESCRIPTION OF THE DRAWINGS

The foregoing and still other objects and advantages of the present invention will be more apparent from the following detailed explanation of the preferred embodiments of the invention in connection with the accompanying drawings.

FIG. 1 is a block diagram of the LED light of the present invention;

FIG. 2 is an exploded perspective view of the lamp head of the LED light of the present invention;

FIG. 3 is a cross-sectional view of the lamp head of the LED light of the present invention;

FIG. 4 is a perspective view of an LED utility light according to one embodiment of the present invention, illustrating the lamp head and flexible neck or stalk in a storage position;

FIG. 5 is a perspective view of the LED utility light of the present invention, illustrating the lamp head and flexible stalk in an extended position;

FIG. 6 is an environmental view illustrating the LED utility light of the present invention being employed within an automobile engine compartment to illuminate an automobile engine; and

FIG. 7 is an exploded side perspective view of the LED utility light of the present invention, illustrating the magnetic means for attachment to a ferromagnetic surface within a workspace.

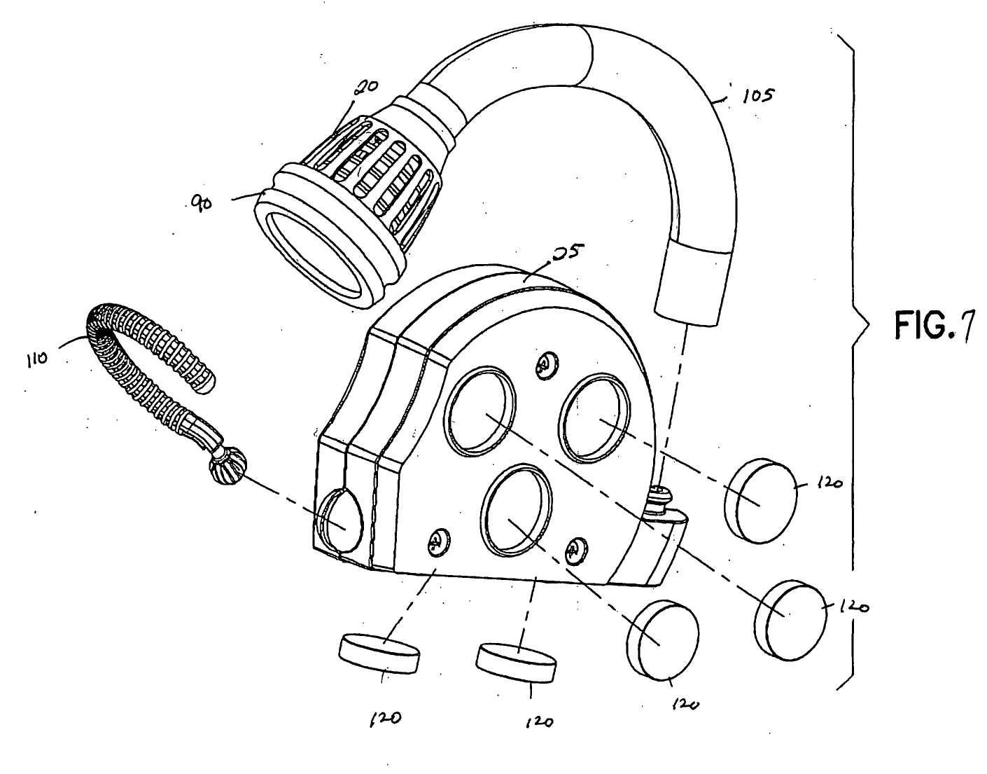

### DETAILED DESCRIPTION OF THE PREFERRED EMBODIMENTS

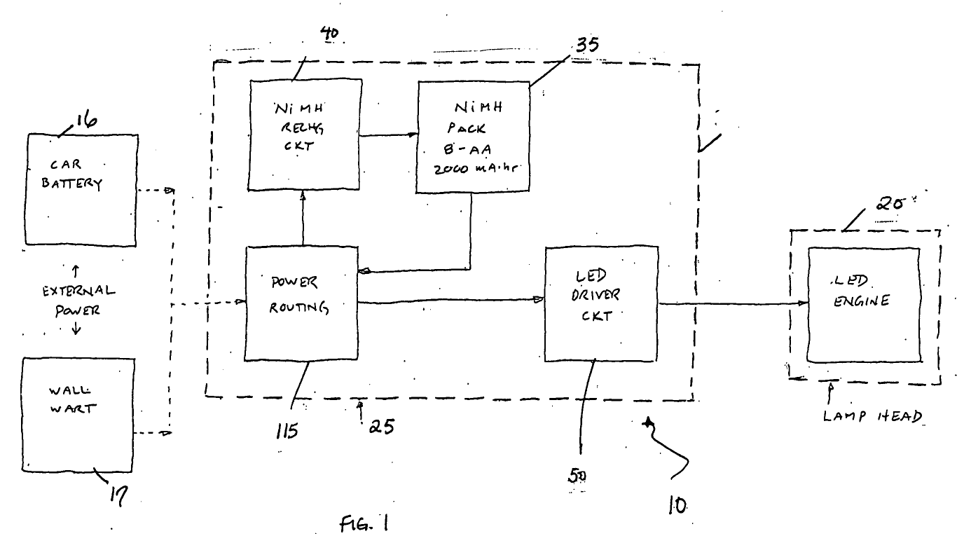

Referring to the drawings and, in particular, FIG. 1 there is illustrated an LED light according to the present invention generally represented by reference numeral 10. LED light 10 preferably has a lamp head 20 and a housing 25. Housing 25 contains a power routing element 115, a rechargeable battery 35, recharge circuitry 40, and LED (light emitting diode) driver circuitry 50.

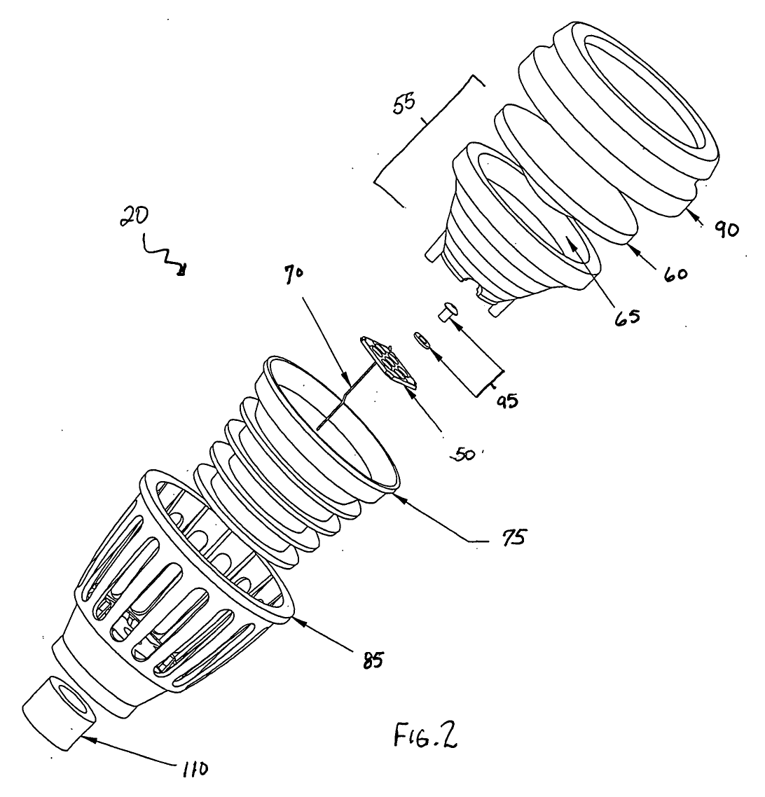

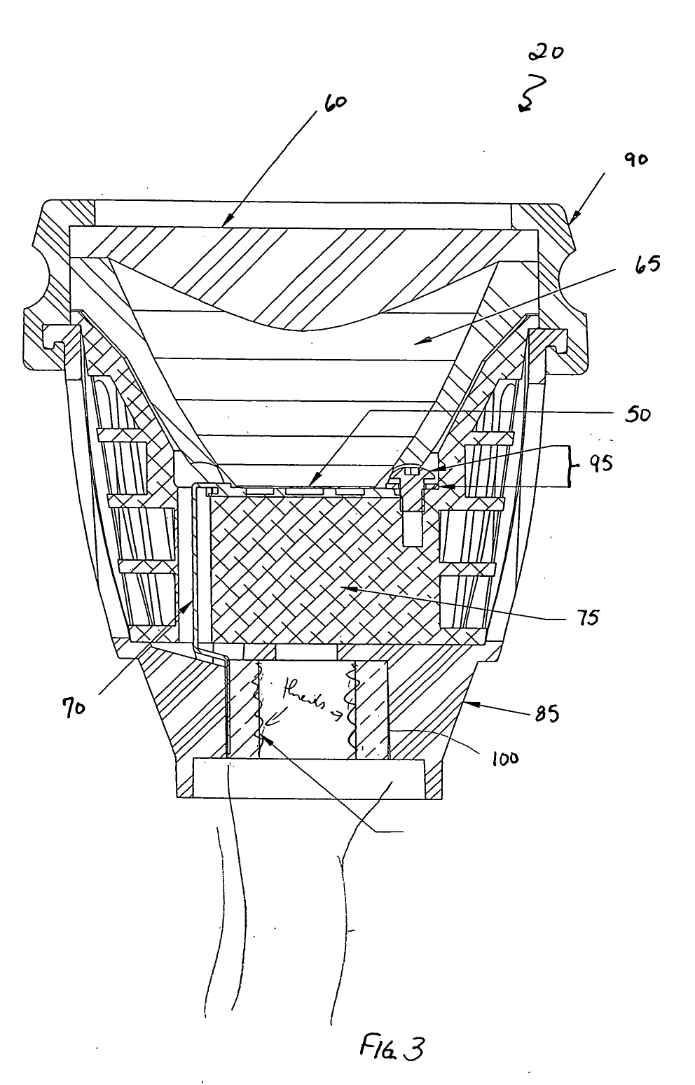

As shown in FIGS. 2 and 3, lamp head 20 houses an LED module 50, an optic assembly 55 comprising a lens 60 and a reflector 65, a power lead 70, and a heat sink 75. LED module 50 is preferably a packaged array of a multiplicity of individual LED semiconductor chips disposed on a substrate. The substrate is preferably engineered for optimizing thermal performance and heat transfer, such as substrates supplied by Lamina Ceramics of Westampton, N.J. LED module 50 preferably incorporates means for electrostatic discharge protection.

LED light 10 employs an LED optical system of the type disclosed in U.S. Published Application Number 2004/0264004 A1 to Jacobson et al., incorporated herein by reference. The '004 Publication is directed to a non-imaging optical system for processing first and second light distributions. The non-imaging optical system includes at least two refractive surfaces, at least one reflective surface nearer to the first light distribution along at least one ray path than the nearer of the two refracting surfaces and the reflective surface. The refractive surfaces cooperate to redirect light edge rays of the first light distribution into the neighborhood of the edge of the second light distribution with a single reflection from the reflecting surface.

More specifically, the disclosed optical system uses an aspheric dielectric lens with two refraction surfaces at the large aperture of a hollow, funnel-shaped reflector. The back surface of the dielectric (the surface facing the reflector) has a higher curvature than the front surface, making the structure more compact. This approach achieves performance comparable to a non-truncated CPC, with much better compactness. Aspect ratios range from 0.4 to 0.7. Moreover, the dielectric lens has acceptably low thickness for cost-effective molding. Unlike the earlier designs, the small aperture of the funnel is advantageously positioned behind the optic, so that a source or detector can be supported by a much larger circuit board or heat sink without shadowing.

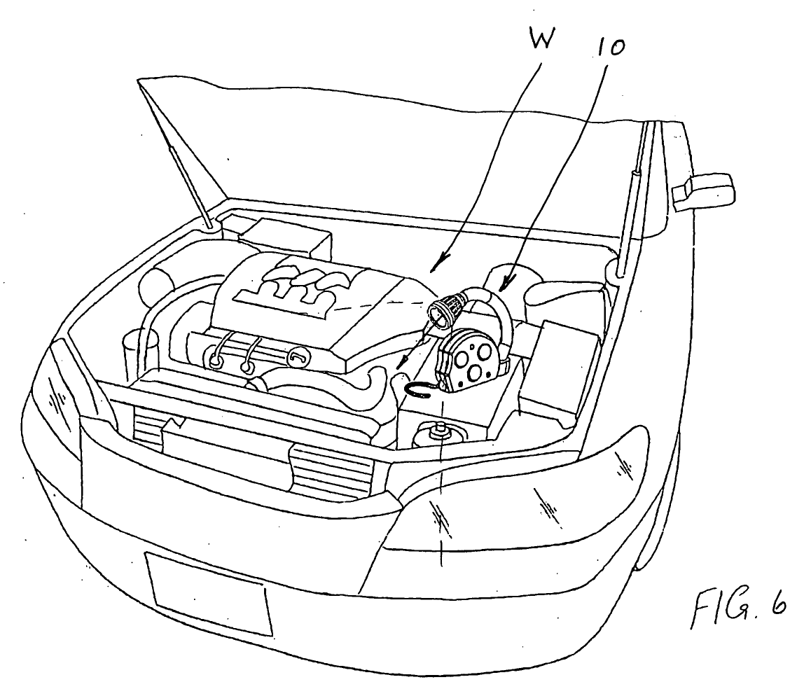

LED emitted light provides a collimated beam having a wide angle of dispersion. LED module 50 and optic assembly 55 provide a substantially uniform beam of light having little diffusion. In a preferred embodiment, LED module 50 and optic assembly 55 provide an illuminated area approximately 18 to 20 inches. Actual prototypes and production components have measured about 19 inches in diameter when the LED light 10 is at a distance of two feet from an object to be illuminated. Preferably, the angle of dispersion of the light beam of LED light 10 is between about 35 to about 45 degrees. The LED light beam provides a uniform and bright light at these angles, thereby enabling illumination within a confined work space. FIG. 6 illustrates illumination of an automobile engine work space W by LED light 10.

Optic assembly 55, comprising lens 60 and reflector 65, is dedicated to LED module 50. The spatial relationship between lens 60 and reflector 65 provides the tolerances necessary to providing a clean beam of light. Optic assembly 55 gathers the uncontrolled light emitted from LED module 50 and directs such light into an output pattern with a relatively constant intensity. Optic assembly 55 produces a substantially uniform beam of light from the output of LED module 50 over a range extended from lamp head 20 to a distance of at least 24 to 32 inches, although the optic assembly 55 produces a substantially uniform beam of light. This uniformity extends to distances of 40 to 50 feet and sometimes more. However, the brightness of an illuminated area will clearly also be a function of the distance from the optic assembly and a function of ambient light conditions.

The output pattern is preferably cone-shaped and provides relatively constant intensity across a plane normal to the axis of the cone. LED module 50 preferably also has at least one heat sink 75 for dispersing the heat generated by LED module 50. Heat sink 75 is preferably a machined unit.

To obtain a clean or uniform beam of light, the optic assembly 55 should be held dimensionally in the correct position relative to LED array 50. In the disclosed design, the position of LED array 50, and the position of optic assembly 55, are controlled by the heat sink, which is a machined unit having reasonably good tolerances. Required tolerances are no tighter than those produced routinely and typically by computer-numerically-controlled machining equipment.

Heat sink 75 is preferably a conical structure and functions to draw heat away from the LED module and transfer it to the ambient air. Heat sink 75 preferably has a series of corrugated protrusions or ribs 107 as shown. Ribs 107 optimize surface area for dissipation of heat. Heat sink 75 is engineered from a suitable electrically and thermally conductive material. A non-limiting example of a thermally conductive material is aluminum. Heat sink 75 also serves to conduct electrical power to LED module 50. Structurally, heat sink 75 further provides the required precise dimensional location of LED module 50 and reflector 65 and support for LED module 50.

Lamp head 20 may optionally have a cage 85, a retaining ring 90, a connecting means 95 for mechanical and electrical connection of the heat sink to LED module 50. Cage 85 protects heat sink 75 from casual contact with heat sensitive materials, such as human skin. Cage 85 also functions to support bushing 100 and to provide an engageable connection with retaining ring 90. Cage 85 is formed of an electrically insulating material such as plastic.

Retaining ring 90 functions to retain the lamp head 20 while providing uniform pressure on optic assembly 55, thus holding reflector 65 and lens 60 in precise coaxial alignment relative to one another. Retaining ring 90 additionally provides protection from mechanical shock and impact as well as a measure of moisture resistance. Retaining ring 90 further provides a simple, tool-free means for field disassembly, enabling replacement of a compromised lens. Retaining ring 90 is preferably formed of an elastic material.

The bushing 100 is formed of an electrically conductive material such as brass. Bushing 100 is installed in cage 85, serving as both a mechanical mounting means as well as an electrical conductor of a polarity opposite to that of the heat sink 75. The bushing 100 may be press fit, threaded or connected by any other known means.

Connecting means 95 may be any means known in the art for providing mechanical and electrical connection. Connecting means 95 is preferably a screw and washer assembly.

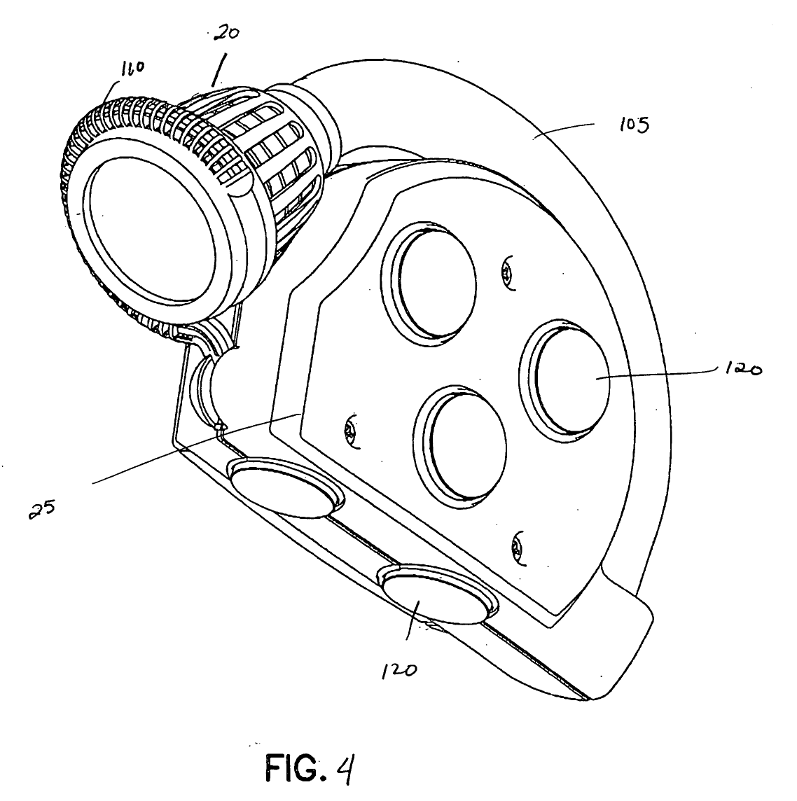

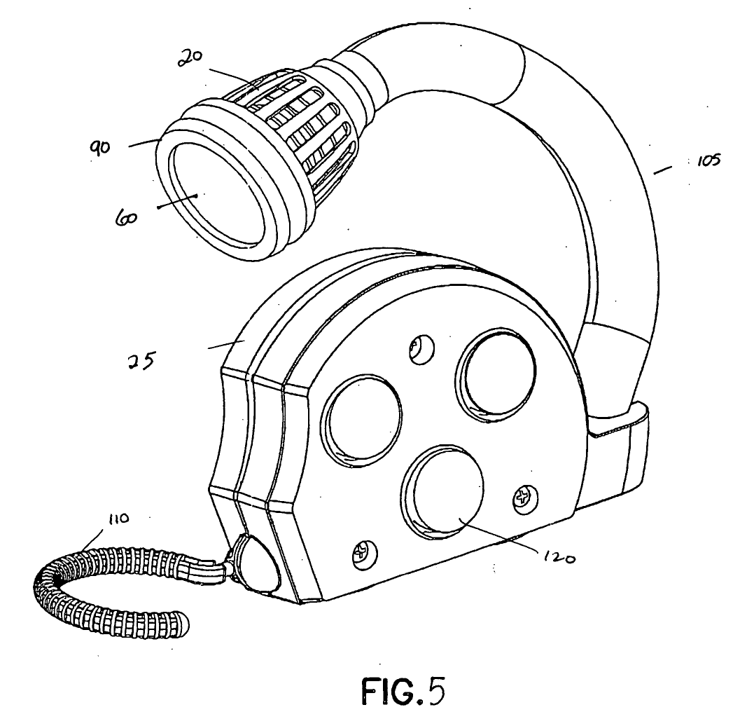

As illustrated in FIGS. 4 and 5, lamp head 20 is coupled to housing 25 by a flexible stalk or neck 105. Flexible stalk 105 is preferably flexible along its entire length and is preferably permanently attached to housing 25. It should be noted that flexible stalk 105 may be flexible in one or a plurality of locations along its length. The lamp head 20 is pivotally mounted to flexible stalk 105 such that the lamp head 20 is positionable along at least two axes.

FIG. 4 illustrates lamp head 20 and flexible stalk 105 in a closed or storage position. When lamp head 20 is in the storage position it may be secured to housing 25 by a hook means 110. Hook means 110 may be any fastening means known in the art. While the hook 110 secures the lamp head 20 in one position (as shown in FIG. 4), it is preferably movable and positionable such that it may support the housing 25 in a plurality of positions. Thus, with hook 110 deployed as shown in FIG. 5, by virtue of a detented ball-and-socket joint 111, the housing 25 can be hung from a support in a plurality of positions or orientations.

Hook means 110 is preferably coupled to housing 25 by a ball and socket-type mechanism. Hook means 110 also functions to provide a means by which to hang LED light 10 from a support. FIG. 5 illustrates lamp head 20 and flexible stalk 105 in at least a partially extended position.

Housing 25 preferably has an external power port (not shown). External or input power may be directed to recharge rechargeable battery 35 via the external power port. External power may alternately be directed to drive LED driver circuitry 45 when rechargeable battery 35 is depleted.

Referring again to FIG. 1, input power may be supplied to recharge circuitry 40 by an automobile battery 16 or a plug-in transformer module commonly known as wall wart or power adapter 17. Input voltage is preferably about 11.5 to about 18 VDC. It should be noted that input power supplied by wall wart 17 may have some ripple effect. Accordingly, recharge circuitry 40 is preferably designed to be immune from such effect. A “smart charger” may be used, which is capable of detecting the state of the battery, and it is self-regulating to optimize recharge. A smart charger provides the most appropriate voltage and current characteristic to a selected battery type, such as a NiMH battery pack, of recharge circuitry 40, and additionally prevents overcharging.

The external power port is adapted to accept 12 VDC from an automotive battery via a cigarette lighter outlet or directly from the battery via “alligator”-type clips. A partially depleted automobile battery has a terminal voltage of approximately 11.5 VDC. A normally running automobile has a system voltage of approximately 14.5 VDC. However, it should be noted that transients common to the automotive electrical system, which boost system voltage to approximately 18 VDC may exist.

The external power port may also be adapted to accept 12 VDC from wall wart 17. The North American standard for input voltage is 120 VAC 60 Hz. Nominal output voltage will be 12 VDC at rated current.

Input power to LED driver circuitry 45 is approximately 8.4 VDC to 18 VDC. Input power will contain some ripple if the power source is a wall wart. Accordingly, LED driver circuitry 45 is preferably designed to be immune to such ripple.

Power routing element 115 enables a user to switch between several modes of operation. A first mode draws internal power from rechargeable battery 35 for normal LED operation. A second mode draws external power to LED module 50 if lighting is desired. A third mode draws external power to the battery recharge circuit, if LED module 50 is not operational. Power routing element 115 may be any mechanical means for switching known in the art such as switch contacts. Power routing element 115 may be solid-state means or any combination of mechanical and solid-state means.

In a preferred embodiment, LED light 10 further has a charge status indicator (not shown). The charge status indicator may be any indicator known in the art such as a small lamp, an audio device or any other signaling means.

Other embodiments are possible that use primary cells (replaceable, non-rechargeable batteries). In these embodiments, the energy source is exclusively the primary cells; there is no external port nor is there any need for power-routing 115 nor for recharge unit 40.

The lamp head 20 is interchangeable between a white light mode and any other commercially available LED color. Non-limited examples include ultra-violet, violet, blue, green, amber, and red. Since there is no such thing as a white LED die, a close approximation of white is commercially obtained by coating blue LED die with various phosphors.

Various lighting applications may benefit from illumination via a colored light other than white. One example includes detection of ultraviolet dyes employed in leak detection and security; another includes red light, which is sometimes employed in low-light conditions to preserve night vision.

The LED module 50 preferably consists of a cell array populated with a prescribed number of LED die. In a preferred embodiment, LED module 50 consists of a Lamina 7-cell array populated with 42 LED die. In a more preferred embodiment, the LED die are wired in a configuration having three in a series and fourteen sets in parallel. Nominal forward voltage of a single die is approximately 3.5 VDC. Accordingly, three LED die in a series provide approximately 10.5 VDC. Nominal forward current is 30 mA per series of die. Accordingly, fourteen sets in parallel provide a forward current of 420 mA.

To provide the brightest light for illumination, however any color LED die may be employed. In an alternate embodiment, LED module 50 has blue ultraviolet LED die. Blue ultraviolet LED may be useful for automotive leak detection as well as for non-automotive uses such as security, adhesive curing, detecting Freon leaks in refrigeration systems and any other known use. In this embodiment, LED module 50 preferably has a Lamina 7-cell array populated with fourteen blue die in the range of 470 nm. In a more preferred embodiment, fourteen blue die are wired in parallel and run at approximately 420 mA at approximately 3.5 VDC. LED module 50 may alternately have twenty-eight blue die in the range of 470 nm. In this embodiment, twenty-eight die are wired in two parallel lines, fourteen in a series, and run at 420 mA at approximately 7 VDC.

Flexible stalk 105 preferably has a quick-release means incorporated therein for allowing rapid removal of the lamp head 20 and changeover from a white lamp head to a UV or any other LED lamp head. The quick-release means preferably has a mechanical mounting system and a set of electrical contacts.

As shown in FIG. 5, housing 25 preferably has a series of attaching means 120 disposed along at least one outer surface of housing 25. Attaching means 120 may be magnets, Velcro, clamp or other suitable attachment means. Attaching means 120 enable housing 25 to be attached to any suitable working surface such as an automobile engine. Alternately, LED light 10 may have clamp or other suitable means for fastening housing 25 to a work space.

The present invention has been described with particular reference to the preferred embodiments. It should be understood that the foregoing descriptions and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. An LED work or utility light comprising:
a lamp head, which houses an array of LED elements;
a housing;
a power source; and
an optical means that takes the output of said LED elements and produces a substantially clean and uniform beam of light over a range extended from said lamp head to a distance of at least 24 to 32 inches.

2. The LED work or utility light of claim 1, wherein said optical means further comprises a lens and a reflector.

3. The LED work or utility light of claim 1, further comprising a heat sink.

4. An LED utility light comprising:
a lamp head, which houses an array of LED elements;
a housing;
a power source;
a flexible stalk that is connected at a first end to said housing and at a second end to said lamp head; and
an optical means that takes the output of said LED elements and produces a substantially clean and uniform beam of light over a range extended from said lamp head to a distance of at least 24 to 32 inches.

5. The utility light of claim 4, wherein said optical means further comprises a lens and a reflector.

6. The utility light of claim 4, further comprising a heat sink.

7. The utility light of claim 4, wherein said power source is a power adapter.

8. The utility light of claim 4, wherein said power source is a battery.

9. The utility light of claim 4, wherein said housing further comprises means for removably securing said utility light to a physical element or to component within a work space.

10. The utility light of claim 4, wherein said means for removably securing is at least one magnet that is disposed on at least one surface of said housing.

11. The utility light of claim 4, wherein said means for removably securing is at least one clamp.

12. The utility light of claim 4, wherein said utility light can be secured to an element in a workspace and wherein a substantially uniform light can be generated in said workspace.

13. The utility light of claim 4, wherein said LED elements emit light which can be focused and directed by adjusting at least a first a lens and a first reflector through said optical means.

14. The utility light of claim 4, wherein said LED elements provide a light having an angle of dispersion between about 35 to about 45 degrees.

15. The utility light of claim 4, wherein said flexible neck has a quick-release means for allowing removal of said flexible neck from said housing.

16. An LED utility light comprising:
a housing having a LED module, secondary optics, and at least one heat sink;
a renewable power source;
a flexible neck that is connected at a first end to said housing and at a second end supports a lamp head that houses an array of LED elements; and
an optical means that takes the output of said LED elements and produces a substantially uniform beam of light over a range extended from said lamp head to a distance of at least five feet,
wherein said flexible neck has a quick-release means for allowing alteration between a lamp head housing white LED die and a lamp head housing blue ultraviolet LED die.

17. The utility light of claim 8, wherein said battery is a disposable replaceable cell.

18. The utility light of claim 8, wherein said battery is a rechargeable cell.
